(19) United States
(12) Patent Application Publication
(10) Pub. No.: US 2021/0104831 A1
(43) Pub. Date: Apr. 8, 2021

(54) HIGH DENSITY ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: SHAN-YONG CHENG, New Taipei (TW); CHAO-CHIEH CHEN, New Taipei (TW)

(21) Appl. No.: 17/065,231

(22) Filed: Oct. 7, 2020

Related U.S. Application Data
(60) Provisional application No. 62/912,035, filed on Oct. 7, 2019.

(51) Int. Cl. H01R 12/71; H01R 13/24

(52) U.S. Cl. CPC H01R 12/71; H01R 13/2435

(57) ABSTRACT

An electrical connector includes an insulative housing with opposite upper and lower surfaces thereon, a plurality of passageways arranged in matrix and extending through the housing in a vertical direction, and plural pairs of contacts retained in the corresponding passageways, respectively. Each passageways receives a pair of contacts reversely arranged with each other. Each contact has a main body extending in a vertical plane, opposite upper contact arm and lower contact arm extending from opposite upper and lower ends of the main body and out of the corresponding upper surface and lower surface with corresponding opposite upper contacting section and lower contacting section thereon for respectively contacting the corresponding PCBs.

### BACKGROUND OF THE INVENTION

### 1. Field of the Invention

The present invention relates generally to an electrical connector, and particularly to the high density electrical connector with the staggered contact arrangement without deteriorating strength of the housing structure.

### 2. Description of Related Arts

As shown in FIGS. 1-3 show the LGA/LGA (Land Grid Array/Land Grid Array) electrical connector for electrically connecting two opposite PCBs (printed circuit boards) or a CPU (Central Processing Unit) or electronic package to a PCB, includes an insulative housing with the passageways in matrix for receiving the corresponding contacts therein wherein the passageways are arranged in a staggered manner between the neighboring rows. Anyhow, when the contact density becomes higher and higher, i.e., the fine pitch, the thickness of the partition walls between the neighboring rows of the passageways gets thinner and thinner, thus jeopardizing the required strength of the housing or tending to forming the incomplete partition walls during injection-molding the housing disadvantageously.

It is desirable to provide an electrical connector with not only the desired density of the contact arrangement for performing the preferred electrical characters but also the sufficient thickness of the partition wall for satisfying the required housing strength.

### SUMMARY OF THE INVENTION

An electrical connector includes an insulative housing with opposite upper and lower surfaces thereon, a plurality of passageways arranged in matrix and extending through the housing in a vertical direction, and plural pairs of contacts retained in the corresponding passageways, respectively. Each passageways receives a pair of contacts reversely arranged with each other. Each contact has a main body extending in a vertical plane, opposite upper contact arm and lower contact arm extending from opposite upper and lower ends of the main body and out of the corresponding upper surface and lower surface with corresponding opposite upper contacting section and lower contacting section thereon for respectively contacting the corresponding PCBs. Each contact further includes a retention section beside the main body for engagement with the housing to retain the contact in position in the passageway. A linking section is unitarily formed between the main body and the retention section for connecting to a contact carrier to assemble the contact into the corresponding passageway in the vertical direction.

### BRIEF DESCRIPTION OF THE DRAWING

FIG. 1 is a perspective view of a traditional electrical connector having the staggered contact arrangement wherein each passageway receives only one contact;

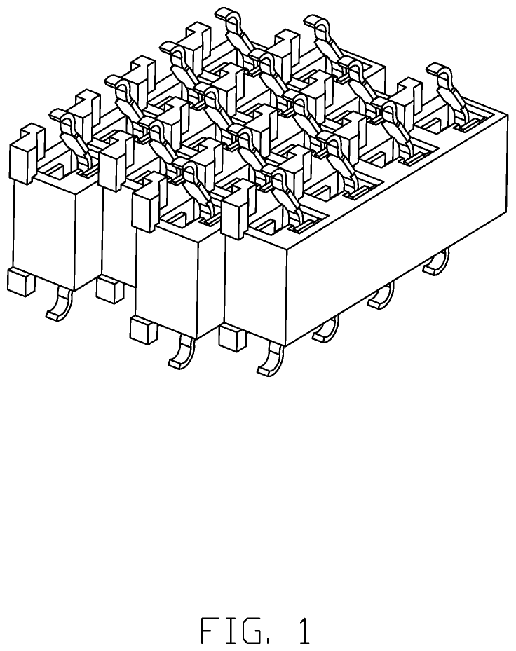

FIG. 2 is a front view of the traditional electrical connector of FIG. 1;

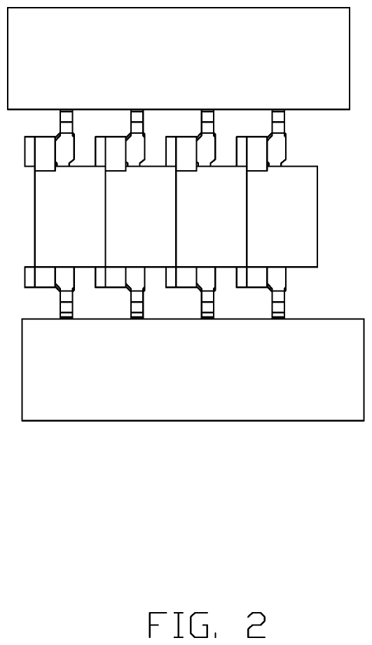

FIG. 3 is a side view of the traditional electrical connector of FIG. 1;

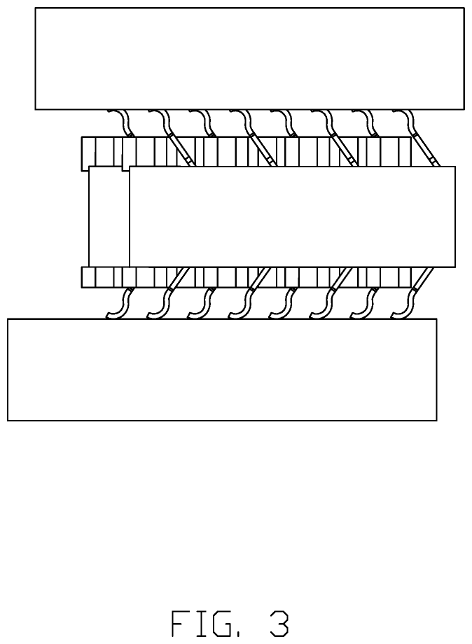

FIG. 4 a perspective view of the electrical connector according to the invention;

FIG. 5 is another perspective view of the electrical connector of FIG. 4;

FIG. 6 is an exploded perspective view of the hermetic electrical adaptor of FIG. 4;

FIG. 7 is another exploded perspective view of the electrical connector of FIG. 6;

FIG. 8 is a top view of the electrical connector of FIG. 4;

FIG. 9 is a bottom view of the electrical connector of FIG. 4;

FIG. 10 is a side view of the electrical connector of FIG. 4;

FIG. 11 is an elevational view of the electrical connector of FIG. 4;

FIG. 12 is a perspective view of the pair of contacts sharing the same passageway; and

FIG. 13 shows two examples of the pin assignment of the corresponding contacts in a top view wherein S represents the signal contacts and G represents the grounding contacts.

### DETAILED DESCRIPTION OF THE PREFERRED EMBODIMENT

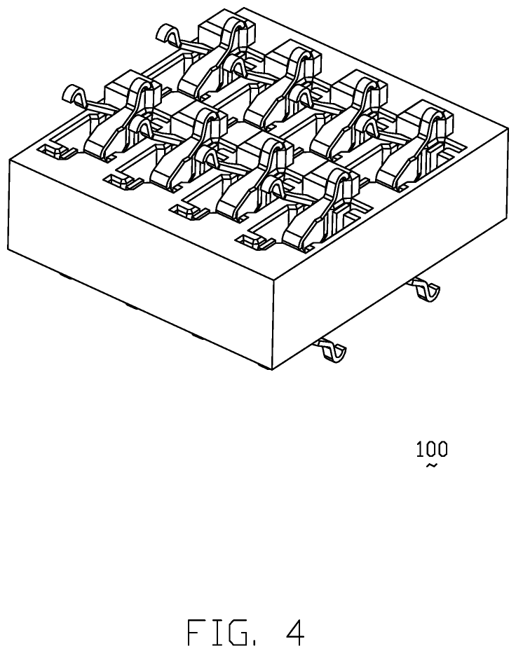

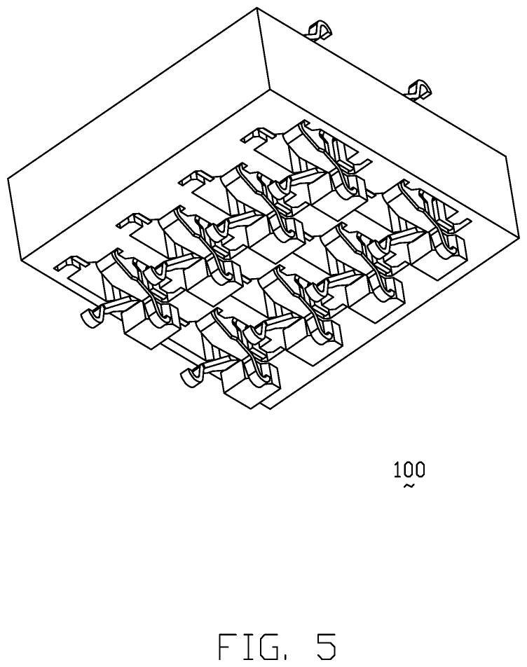

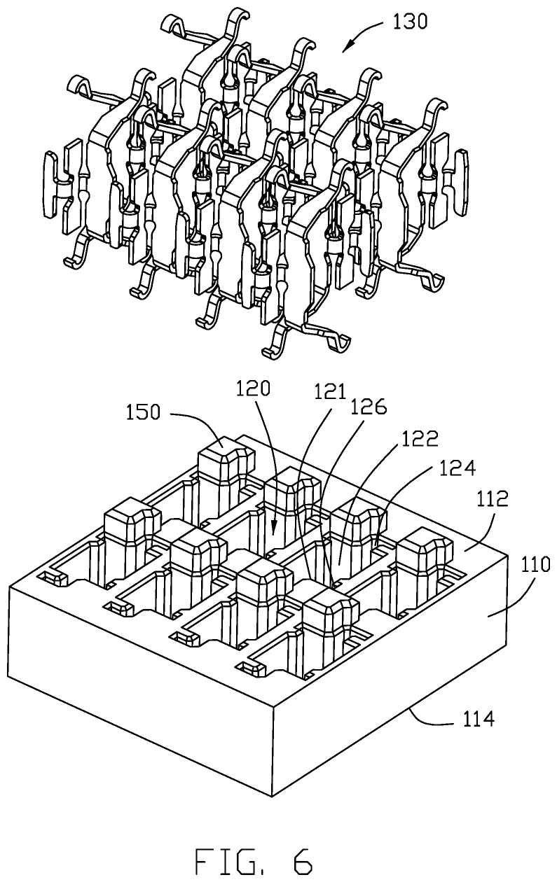

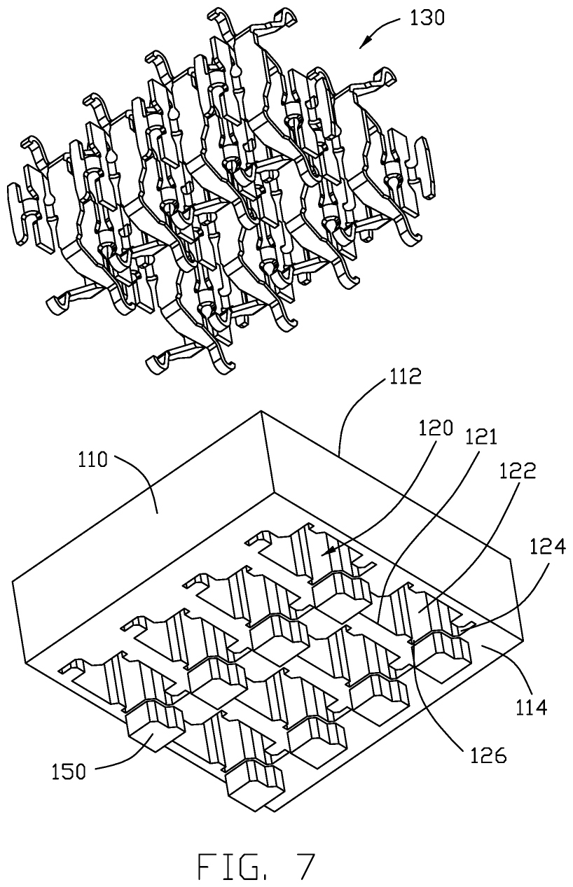

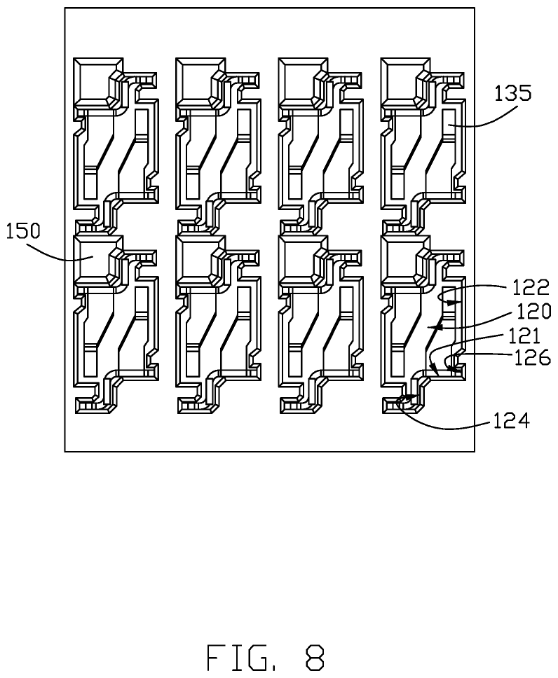

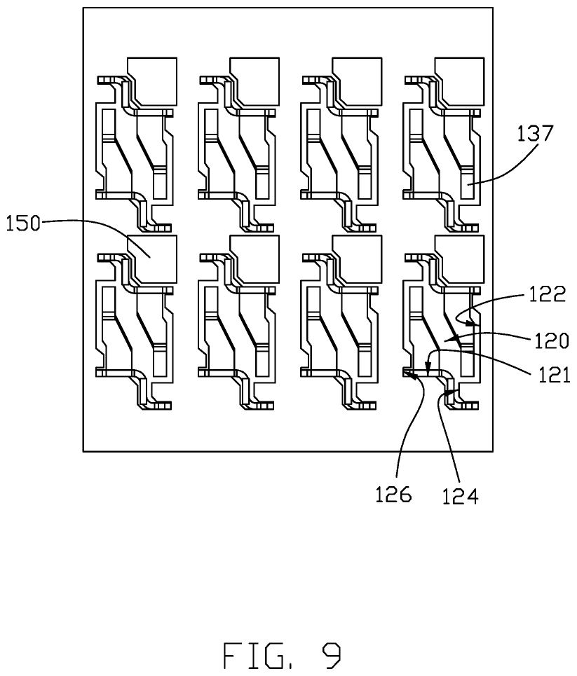

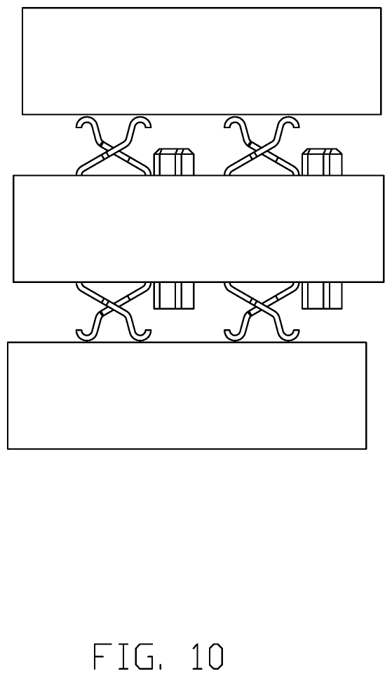

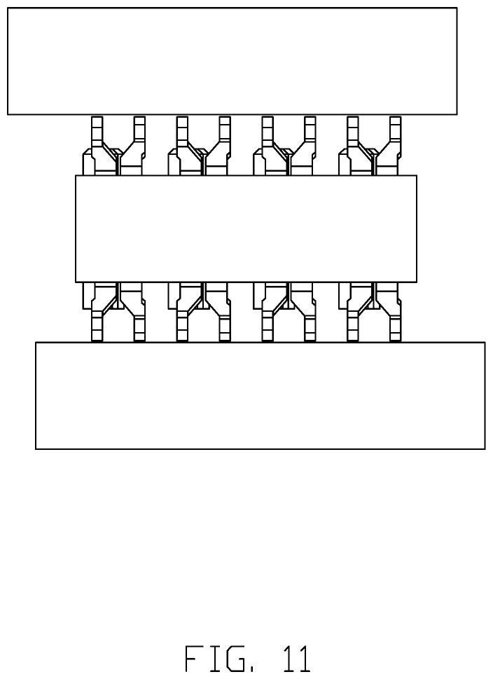

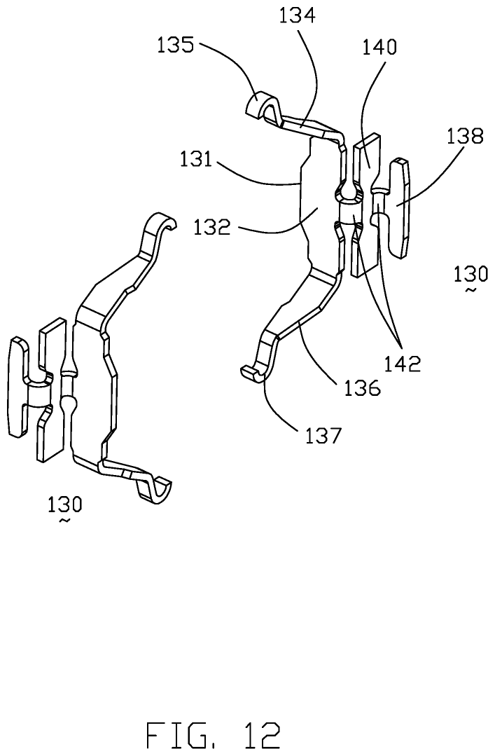

Referring to FIGS. 4-13, an electrical connector 100 includes an insulative housing 110 with opposite upper surface 112 and lower surface 114, and a plurality of passageways 120 extending through the housing 110 in the vertical direction. The passageways 120 are arranged in matrix. In this embodiment, the passageways are aligned with one another along both the row direction and the column direction so as to perform the maximum strength compared with those arranged in the staggered manner between the neighboring rows.

The passageway 120 is symmetrically configured with regard to the center to include a main portion 122 and a pair of L-shaped retention slots 124 on two opposite sides in the front-to-back direction. Plural pairs of contacts 130 are received within the corresponding passageways 120. Each passageway 120 receives one pair of contacts 130 reversely arranged with each other. Each contact 130 includes a planar main body 132 extending in a first vertical plane, opposite resilient upper and lower contact arms 134 and 136 respectively extending from opposite upper end and lower end thereof and out of the upper surface 112 and the lower surface 114 with corresponding contacting sections 135 and 137 thereof. Notably, the upper contact arm 134 and the lower contact arm 136 are aligned with and symmetrical with each other in an mirror-image manner. Each contact 130 further includes a planar retention section 138 extending in a second vertical plane parallel o the first vertical plane. A linking section 140, which is used to link with the contact carrier (not shown) for assembling the contact 130 into the corresponding passageway 120, is unitarily formed between the main body 132 and the retention section 138 and extends in a third vertical plane perpendicular to both the first vertical plane and the second vertical plane. Notably, a pair of curved joints 142 are located on two sides of the linking section 140 for joining the main body 132 and the retention section 138, respectively. The main portion 122 of the passageway 120 further includes a pair of grooves 126 opposite to the pair of slots 124. A plurality of standoffs 150 are formed on both the upper surface 112 and the lower surface 114 adjacent to the corresponding passageways 120 so as to provide support for confrontation with the corresponding PCB or CPU.

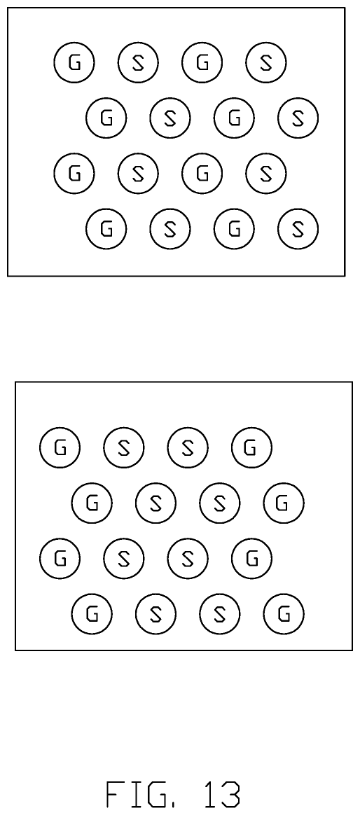

After assembled, the retention section 138 and the linking section 140 are received within the L-shaped slot 134, the main body 132 abuts against an interior face 121 in the passageway 120 with an outer edge 131 is received within the groove 126. Notably, the outer edge 131 may function as another retention mechanism opposite to the retention section 138 so as to cooperate with the retention section 138 to have the contact 130 retained in the passageway 120 in a balanced manner. As shown in FIG. 13, each pair of contacts 130 sharing the same passageway 120 can be either the differential pair for high speed signal transmission, or both the grounding contacts for shielding/grounding. Understandably, the contacts 130 of the differential pair are closely arranged with each other without the partition wall therebetween, may enhance the electrical characters thereof advantageously.

In conclusion, the invention is to provide a pair of identical contacts, preferably reversely arranged with each other, i.e., being symmetrical with regard to the center, within one common passageway of the housing, wherein in a top view, the contacting sections/points of this pair of contacts are not aligned with each other in either the row direction, i.e, along which the contact arm extends, or the column direction perpendicular to the row direction, but offset from each other in both the row direction and the column direction so as to maximize the distance between the neighboring contacting sections. In this embodiment, both the upper contact arm and the lower contact arm are resilient with the corresponding contacting sections thereon; alternately, the lower contact arm may be relatively rigid with the solder ball thereon, i.e., the BGA (Ball Grid Array), for mechanically soldered upon the PCB. In this embodiment, the main body, the retention section and the linking section therebetween of the contact, i.e., the contact without the upper contact arm an the lower contact arm, forms a Z-shaped or S-shaped configuration in a top view to have the corresponding retention section spaced from the main portion of the passageway so as to simplify the structure of the contact exposed in the main portion of the passageway, i.e., only the planar main body, thus avoiding any unwelcomed interaction between the pair of contacts sharing the same/common passageway. In this embodiment, in a top view in each pair of contacts in the same passageway, the upper contact arms of the pair of contacts are aligned with each other in a first transverse direction while the retention section of one contact is aligned with the main body of the other contact in a second transverse direction perpendicular to the first transverse direction.

What is claimed is:

1. An electrical connector comprising:
an insulative housing defining opposite upper surface and lower surface in a vertical direction;
a plurality of passageways extending through the housing in the vertical direction, each of said passageway forming a main portion;
plural pairs of contacts disposed in the corresponding passageways, respectively, each pair of contacts mutually communicatively retained in one same passageway, and each contact having a main body retained in the main portion, opposite resilient upper and lower contact arms extending from opposite upper and lower ends of the main body out of the upper surface and the lower surface, respectively.

2. The electrical connector as claimed in claim 1, wherein the pair of contacts are identical with each other.

3. The electrical connector as claimed in claim 1, wherein the upper contact and the lower contact are identical and aligned with each other in the vertical direction.

4. The electrical connector as claimed in claim 1, wherein each of said upper arm or said lower arm forms a contacting section, and in a top view taken along the vertical direction, the contacting sections of the pair of contacts in the same passageway are offset from each other along both the row direction perpendicular to the vertical direction, and the column direction perpendicular to both the vertical direction and the row direction.

5. The electrical connector as claimed in claim 1, wherein each contact further includes a retention section spaced from the main body and isolated from the main portion.

6. The electrical connector as claimed in claim 5, wherein a linking section is unitarily formed between the retention section and the main body for connecting to a contact carrier to assemble the contact into the passageway.

7. The electrical connector as claimed in claim 6, wherein the main body extending in a first vertical plane while the retention section extends in a second vertical plane parallel to the first vertical plane.

8. The electrical connector as claimed in claim 7, wherein the linking section extends in a third vertical plane perpendicular to both the first vertical plane and the second vertical plane.

9. The electrical connector as claimed in claim 8, wherein each passageway further includes a pair of L-shaped slots each receiving the retention section and the linking section of the corresponding contact.

10. The electrical connector as claimed in claim 9, wherein each passageways further includes a pair of grooves opposite to the pair of L-shaped slots, each groove receiving a side edge of the main body of the corresponding contact.

11. The electrical connector as claimed in claim 5, wherein in each pair of contacts, the linking section of one contact is aligned with the main body of the other contact in a transverse direction perpendicular to the vertical direction.

12. The electrical connector as claimed in claim 11, wherein in each pair of contacts, the upper contact arms are aligned with each other in another transverse direction perpendicular to said transverse direction in a top view.

13. An electrical connector comprising:
an insulative housing with a plurality of passageways extending therethrough in a vertical direction, each passageway being communicatively equipped with a slot; and
at least one contact disposed within each passageway, the contact including a planar main body, a retention section and a linking section therebetween, at least a resilient upper contact arm extending upwardly from an upper edge of the main body; wherein
the main body is disposed in the passageway while both the retention section and the linking section are disposed in the retention slot.

14. The electrical connector as claimed in claim 13, wherein an upper end of the linking section is configured to be originally connected to a contact carrier which is used to downwardly assemble the contact into the corresponding passageway.

15. The electrical connector as claimed in claim 13, wherein in each contact, the main body extends in a first vertical plane, the retention section extends in a second vertical plane parallel to the first vertical plane, and the linking section extends in a third vertical plane perpendicular to both the first vertical plane and the second vertical plane.

16. The electrical connector as claimed in claim 13, wherein each contact further includes a resilient lower contact arm extending from a lower end of the main body, and a projecting length of the lower contact arm is less than a width dimension of the passageway along an extension direction of the lower contact arm in a top view taken along the vertical direction when the contact is in a relaxed manner.

17. The electrical connector as claimed in claim 13, wherein each passageway further encloses another contact to form a pair, and said pair of contacts in the same passageway are identical to each other in a reversely symmetrical manner.

18. The electrical connector as claimed in claim 17, wherein the upper contact arms of the contacts in the same passageway are side by side aligned with each other along a first transverse direction.

19. The electrical connector as claimed in claim 18, wherein in each passageway, the retention sections of said pair of contacts are spaced from each other in a second transverse direction perpendicular to the first transverse direction.

20. The electrical connector as claimed in claim 19, wherein in each passageway, the retention section of one contact of said pair of contacts is aligned with the main body of the other contact of said pair of contacts in said second transverse direction.
